(19) United States
(12) Patent Application Publication
(10) Pub. No.: US 2026/0112776 A1
(43) Pub. Date: Apr. 23, 2026

(54) Lignin-Based Separators For Batteries Using A Dry Fibrillation Method

(71) Applicant: Board of Trustees of Michigan State University, East Lansing, MI (US)

(72) Inventors: Chengcheng FANG, Okemos, MI (US); Huanhuan JIA, Tacheng (CN)

(73) Assignee: Board of Trustees of Michigan State University, East Lansing, MI (US)

(21) Appl. No.: 19/366,970

(22) Filed: Oct. 23, 2025

Related U.S. Application Data
(60) Provisional application No. 63/710,805, filed on Oct. 23, 2024.

(51) Int. Cl. H01M 50/429; H01M 50/403; H01M 50/426; H01M 50/44; H01M 50/489

(52) U.S. Cl. CPC H01M 50/429; H01M 50/403; H01M 50/426; H01M 50/44; H01M 50/489

(57) ABSTRACT

Disclosed is a lignin based battery cell separator. The lignin may include a technical lignin that is sulfonated. The lignin may be ground and pressed with a polymer binder. The polymer binder may include at least a portion that dry fibrillates.

### CROSS-REFERENCE TO RELATED APPLICATIONS

This application claims the benefit of U.S. Provisional Application No. 63/710,805, filed on Oct. 23, 2024. The entire disclosure of the above application is incorporated herein by reference.

### FIELD

The present disclosure relates to a separator for a battery and a method of making the same, and particularly to a lignin based separator and a dry fibrillation method for making the same.

### BACKGROUND

In a battery, a separator plays an important role in preventing internal short circuits, averting thermal runaway, and influencing the C-rate and lifespan performance of battery technologies. Known separators generally require enhancement to meet the high stability and longevity standards necessary for maintaining the efficacy and reliability of battery technologies. The separator is placed between an anode portion and a cathode portion of a battery cell.

### SUMMARY

Lignin is a natural polymer accounting for one-third of plant biomass. A separator formed substantially of the lignin, such as up to about 99% by mass or weight percent (wt %), may be formed into a separator having a thickness of 1 micrometer (micron or μm) in a battery. The battery may be lithium ion based, or sodium ion based and other metal ions (aluminum, zinc, magnesium, etc.).

The separator may include materials or compositions other than lignin alone, such as polytetrafluoroethylene (PTFE), polyvinylidene fluoride (PVDF), and/or other binders (e.g., polymer binders or cross-linkers). The amount in the separator that is not lignin may be about 1 wt % to about 20%. A dry fibrillation method may be employed with the PTFE that allows for forming the separator that is low energy consumption and a 100% conversion.

Battery cells may be of various types with the lignin based separator such as graphite or silicon-graphite (Si-Gr) NMC811 cells. Such cells with lignin-based separators demonstrated improved cycling performance compared to similar cells with other separators, such as the Celgard®2325 separator sold by Celgard, LLC having a place of business at Charlotte, NC. The Celgard®2325 separator is disclosed herein as a comparative example for various comparisons to the lignin based separators of various compositions. The improvement, without being bound by the theory, based on a lower polarization of the lignin-based separator.

The lignin based separator further includes sulfonate functional groups, and, therefore, may also be referred to as sulfonated lignin and/or lignin sulfonate and/or lignosulfonate. The sulfonate functional groups induce formation of a sulfur-rich interfacial layer in both cathode and anode materials. This, and other features discussed herein, such as low cost and high manufacturing feasibility, allow for single-layer functional separators for high-performance batteries.

Separators, a passive element positioned between the anode and cathode, play a role in preventing internal short circuits, facilitating ion transport, and influencing rate and cycling performance in in selected battery cells, such as lithium-ion batteries (LIBs). High energy density, long cycle life, and enhanced safety of LIBs may be achieved and/or enhanced with a separator that is lightweight, thin, and exhibits high electrolyte wettability, good mechanical strength, and thermal stability such as lignin based separators, as discussed herein. The lignin based separators may further provide high safety, mechanical and electrochemical performances, low cost, and scalability.

In addition to acting as the physical barrier between the cathode and anode, functional separators further enhance electrochemical performances due to their special functional groups, unique porous structure, and/or modified separator-electrolyte interface interactions. These features facilitate the rapid formation of stable solid electrolyte interphase (SEI) by leveraging the strong affinity between the functional groups and lithium ions or by regulating ion flux in the interfaces.

Wet processes, such as using a solvent or liquid solution to assist in processing a separator material, may increase costs and potentially introduce environmental challenges due to the volatilization of solvents, which may limit their suitability for large-scale battery applications. A lignin-based battery separator, as disclosed herein, may be processed and/or manufactured using a dry method, include a dry fibrillation method.

As disclosed herein, according to various embodiments, a lignin-based battery separator composition may include a polymer binder such as polytetrafluoroethylene, polyvinylidene fluoride, or combinations thereof. The polymer binder may include polytetrafluoroethylene with a selected mean particle size, such as 675 micrometers (PTFE (675)) and/or a mean particle size of 480 micrometers (PTFE (480)). According to various embodiments, a lignin-based battery separator composition may include PTFE (675) and lignin. According to various embodiments, a lignin-based battery separator composition includes a chain-extended or fibrillated polymer binder, such as PTFE (675), and lignosulfonate, and optionally PTFE having a mean particle size of 480 micrometers (PTFE (480)) and optionally polyvinylidene fluoride. According to various embodiments, a battery separator composition includes a chain-extended or fibrillated PTFE (675), and lignin, and optionally any other fibrillated PTFE and optionally polyvinylidene fluoride (PVDF). According to various embodiments, the disclosed lignin based separator may be used in a battery cell that includes a lithium-ion battery, a sodium-ion battery, a lithium-metal battery, or the like.

According to various embodiments, the disclosed lignin based separator may be made according to an appropriate process or method. According to various embodiments, the method may include drying a lignin and a polymer binder, grinding the lignin and polymer binder, and flattening the ground mixture of the lignin and polymer binder to form a film. According to various embodiments the lignin based separator may be formed by first adding and mixing/blending lignin powder (such as lignosulfonate) to PTFE (675), and optionally adding a different fibrillated extended chain PTFE (such as PTFE (480)) and/or PVDF to the composition. The process may then, second, include grinding the mixed composition. The process may then, third, include pressure rolling (including pressing) the ground composition on a continuous basis between multiple spaced apart calendaring rollers having parallel axes, to reduce the thickness. The process may then, fourth, include repeating the pressure rolling one or more additional times to obtain the desired output sheet or film thickness. The process may then, fifth, include cutting the final output sheet or film to a desired peripheral size. The process may then, sixth, include mounting the cut sheet as a separator within a battery housing between spaced apart electrodes.

In the process, the mixing, grinding and rolling may all be performed in a dry manner without a liquid. A rotating impeller may be used for mixing the raw materials in a tank. Furthermore, a high-shear mixer or twin-screw extruder may be employed for the grinding step to provide sufficient shear forces in the mechanical process to create the fibrillated polytetrafluoroethylene (675) and lignosulfonate composition film. A two-roll mill may be used for further fibrillation and thickness tuning. A mechanical die or knife can be used for the cutting. The adding, mixing, grinding, rolling and cutting may be, such as preferably, conducted at room temperature, although heating may be employed for one or more of the steps. In a laboratory or small batch setting, the mixing can be done in a manual manner with a stirring rod, and the grinding can be performed with a mortar and pestle, or the like.

In the composition of the lignin based separator, the composition may include various ratios or amounts. For example, according to various embodiments, the lignin based separator may include the lignin, which may be a sulfonated lignin, in the amount of about 80 to 99 weight percent (wt. %) of the composition, including about 85-99 wt %, and further including at least 90 wt. %. The PTFE (675), and optionally PTFE (480) and optionally PVDF, are collectively about 1-20 wt. % of the composition of the lignin based separator. According to various embodiments, there is at least twice as much of the PTFE (675) as the other non-lignin materials therein.

Herein, a lignin-based ultrathin, highly thermally stable separator is disclosed as produced via sulfonated lignin (also referred as lignosulphonate materials) and a dry processing method with low energy consumption and a conversion rate of greater than 99% and generally about 100%. Selected component ratios, the lignin-based separator composition, such as 5 wt % PTFE (675), 2.5 wt % PTFE (480), 2.5 wt % PVDF, and 90 wt % sulfonated lignin achieved balanced mechanical property, electrochemical performance, and thermal stability. The separators containing lignosulfonate of 90 wt % show excellent thermal stability and long-term cycle performance when used to manufacture selected battery cells, such as graphite ∥NCM811 cells. Moreover, the cost and the manufacturing of the lignosulphonate separators is sufficiently economical and lower than selected alternative separators.

### BRIEF DESCRIPTION OF THE DRAWINGS

The drawings described herein are for illustrative purposes only of selected embodiments and not all possible implementations, and are not intended to limit the scope of the present disclosure.

FIG. 1A is a schematic illustration of a process of making a lignin-based separator film, according to various embodiments;

FIG. 1B includes schematic illustrations of enlarged portions from FIG. 1A;

FIG. 2 is a schematic illustration of a battery cell, according to various embodiments;

FIG. 3A is a cross-sectional view of a lignin-based separator obtained with a scanning electron microscope, according to various embodiments;

FIG. 3B is a top view of a lignin-based separator obtained with a scanning electron microscope, according to various embodiments;

FIG. 4A is a graph of measured tensile strengths of lignin-based separators at different thicknesses and different total compositional percents;

FIG. 4B is a graph of a strain shown as a percentage stretching of ligand-based separators according to various compositions at different thicknesses;

FIG. 5 is a schematic illustration of shrinkage due to thermal testing of various compositions of separators;

FIG. 6 is a graph illustrating a total resistance of a cell having separators of various compositions;

FIG. 7 is a graph of a voltage profile of a test battery cell having separators of various compositions;

FIG. 8 is a graph illustrating capacity retention of battery cells with separators of various compositions;

FIG. 9 is a graph of voltage relative to specific capacity of battery cells with separators of different compositions;

FIG. 10 is a capacity retention graph of battery cells with different separators at different compositions and at various cycles;

FIG. 11 is a graph of a charging state at constant voltage and a cycle number of battery cells with separators of different compositions; and

FIG. 12 is a schematic illustration of a circuit for an electrical impedance spectroscopy testing.

Corresponding reference numerals indicate corresponding parts throughout the several views of the drawings.

### DETAILED DESCRIPTION

Herein is described a lignosulfonate-based separator that may be used as a battery cell separator. The separator may be ultrathin, such as about one (1) micrometer (μm), about 15 μm or less, including about 25 μm or less in thickness. The separator utilizing an in situ PTFE fibrillation dry method, which is highly scalable and may be widely adopted to produce dry electrodes and solid electrolyte films. The lignin for the lignosulfonate-based separator may be derived from biomass as it is a natural polymer found in plant cell wall and may be produced as byproducts of chemical pulping and biorefinery processes. For example, lignosulfonate may be a technical lignin, such as produced through sulfite pulping process by Borregaard having a place of business in Sarpsborg, Norway. Lignosulfonate is a type of technical lignin that is fully soluble in water, but not soluble in organic solvents, such as liquid electrolytes. Lignosulfonate contains abundant sulfonate groups and exhibits excellent binding and dispersing properties, which are appropriate for separators using a dry method. The dry method disclosed herein, especially as compared to manufacturing methods such as facile filtration, electrospinning, and casting-and-drying, is eco-friendly, low-energy consumption, and cost-effective. It allows for large-scale manufacturing as well as for thickness customization and with high raw material conversion, such as greater than about 95% including nearly and/or including 100% raw material conversion.

A disclosed separator may be formed as a separator film that is lignin based, such including the lignosulfonate, also referred to as sulfonated lignin. The separator may have a composition that is at least about 80 weight percent (wt %), including at least about 90 wt. % of lignin, including at least about 99 wt %, and further including almost solely the lignosulfonate and about and/or at least about 1 wt %, including about 10 wt. %, and further including about 20 wt % of a polymer binder. The polymer binder may include PTFE with different crystal structures and PVDF. The different polymer binders may make the total polymer binder in the composition in selected and various ratios. Chain-extended PTFE can be elongated into fibrils by shear force, and building a heat-resistant polymer matrix and adhering to the other powdery components to form a free-standing thickness-customized film at room temperature.

Separators formed of the selected compositions may be formed into sheets that are thin and/or ultrathin. A separator, which may also be referred to as a separator film may be an ultrathin film. The ultrathin film may be no more than 25 μm thick, further including no more than 15 μm thick, and further including not more than 1 μm. The ultrathin separator exhibits zero thermal shrinkage up to 180° C., and demonstrates improved cycling stability in high-loading graphite∥NCM811 and Si-Gr|NCM811 full cells, especially compared to that of alternative separators, such as the Celgard®2325.

The sulfonate functional groups in lignosulfonate used to form a lignin-based separator may promote a formation of sulfur-rich SEI and cathode electrolyte interphase (CEI) layers. The sulfur rich SEI and CEI layers may reduce interface resistance and facilitate ion transport in a battery.

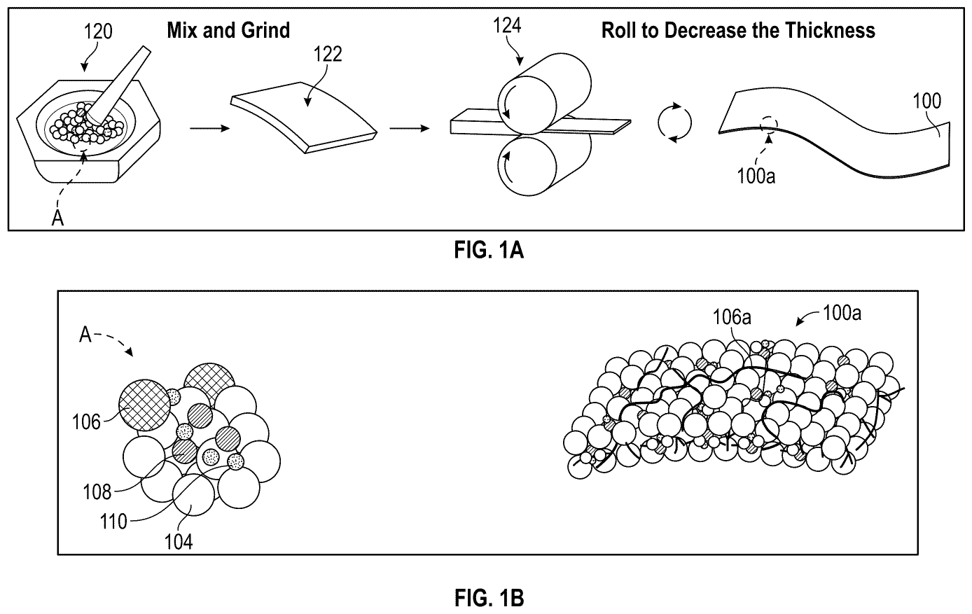

FIG. 1A and FIG. 1B schematically illustrate a process of fabricating or forming a lignin based separator or separator film 100 with lignosulfonates 104 and selected one or more polymer binders. The lignosulfonates 104 may be sourced or formed in any appropriate manner, such as that discussed above. The polymer binders may be selected from any appropriate polymer binders, including PTFE (675) 106, PTFE (480) 108, and/or polyvinylidene fluoride (PVDF) 110. The polymer binders may be used separately and/or together in various wt % as discussed herein.

According to various embodiments, the separator film 100 may be formed or produced according to the process illustrated in Fig. A1. The materials may be gathered and/or sourced from appropriate sources. As noted above, the lignosulfonates may be supplied by Borregaard. The PTFE (675), PTFE (480), and PVDF may be obtained from commercial suppliers, such as those sold by Sigma having a place of business at Burlington, MA, MSE Supplies having a place of business at Tucson, AZ, and MTI corporation having a place of business at Richmond, CA, respectively. All of the constituents are dried, together or separately, at 60 degrees centigrade (° C.) for at least 12 hours before use. The process may be the same or similar for making the lignin based separator of various constituent ratios, such as time for each step. However, the final separator may have a selected thickness and include fibrillation achieved through the dry process as discussed herein.

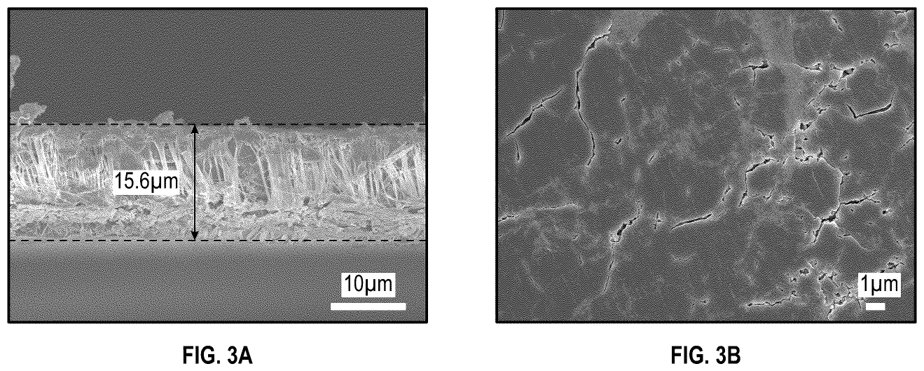

According to various embodiments, the separator film 100 may have a thickness 112, which is a cross-section thickness of the film, an example of which is illustrated in FIG. 3A. The thickness of the separator film 100 may be formed, as discussed herein. The thickness 112 is generally between a first planar surface and a second planar surface of the separator film 100 such as formed by the rollers 124. According to various embodiments, the thickness of the separator film 100 may be about 25 μm. The exemplary separator film 100 may include constituent amounts such as 5 wt % PTFE (675), 2.5 wt % PTFE (480), 2.5 wt % PVDF, and 90 wt % lignosulfonate (LG). The dried PTFE (675), PTFE (480), PVDF, and LG are weighed with the amount of 800 mg in the ratio noted above. The constituents may be mixed and/or ground in a selected system such as a grinding system 120, which may include a mortar and pestle. The mixture may be ground and adhered to and/or as an initially film 122 with thickness of approximately 300 μm by pestle in the mortar. The initial film 122 may then be thinned or pressed. The pressing process may include placing the initial film 122 between the two rollers of the roller press to decrease the thickness via narrowing the gap between the two rollers. During this process, the gap distance may be successively narrowed for each pass of the initial film 122, until the final film 100 is formed. The succussive narrowing may be by 10 μm each time until the roller was basically free of pressure.

During the process as illustrated in FIG. 1A, various constituents may be fibrillated. For example, the PTFE (675) can be fibrillated by shear force and the film gradually becomes thinner and more compact. For example, as shown schematically in FIG. 1B an enlarged portion 100a of the film 100 is illustrated. At least some of the PTFE (675) may be fibrillated to form fibers 106a.

The separator film 100 including the lignosulfonate, PVDF, and PTFE can be obtained. A thickness of the film may be measured by electronic thickness gauge to about 25 μm and/or with various systems such as measuring with a scanning electron microscope (SEM) when the thickness of the film 100 was less than about 25 μm.

The processes discussed above are conducted in air with ambient humidity below 30%. The final separator film, according to various embodiments discussed herein per the process discussed above, may be cut into pieces and heated at 100° C. in a vacuum oven for analysis as discussed herein.

Lignosulfonate is a primary constituent and may be a primary structural material for the separator for various purposes, such as its sustainability, low relative cost, insolubility in organic liquid electrolytes, abundant sulfonate functional groups, and excellent binding and dispersing properties. The lignosulfonate 100. The lignosulfonate, according to various embodiments, includes various constituents including those illustrated in Table 1 below. The ash content of lignosulfonate samples was measured following the TAPPI T 212 om-93 standard, where 1-2 g of oven-dried sample was heated in a crucible up to 525° C. at a rate of 5° C./min and held at that temperature for 4 hours. The carbon, hydrogen, and nitrogen contents were analyzed using a PerkinElmer 2400 Series II CHN elemental analyzer, while sulfur content was measured with an ICP-OES (iCAP Duo 6000 series, Thermo Fisher).

TABLE 1
The ash content and elemental analysis of the lignosulfonate (LG).

| | | | C | H | N | S | Mg | P | K |
|---|---|---|---|---|---|---|---|---|---|
| Processing | Resources | Ash Content | (%) | (%) | (%) | (%) | (ppm) | (ppm) | (ppm) |
| Lignosulfonate | Softwood | 11.32 | 65 | 6.0 | 0.1 | 5.80 | 1673 | 7 | 2253 |
| | | (0.12) | (0.1) | (0.02) | (0.02) | (0.16) | (55) | (6) | (67) |

| | | Ca | Na | B | Zn | Mn | Fe | Cu | Al |
|---|---|---|---|---|---|---|---|---|---|
| Processing | Resources | (ppm) | (ppm) | (ppm) | (ppm) | (ppm) | (ppm) | (ppm) | (ppm) |
| Lignosulfonate | Softwood | 39337 | 1603 | 6 | 11 | 138 | 61 | 6 | 45 |
| | | (1144) | 411) | (1) | (1) | (9) | (1) | (4) | (20) |

As illustrated in FIGS. 1A and 1B, the lignin-based separator 100 is produced by a binder fibrillation-based dry method, in which the powders of lignosulfonates and polymer binders were firstly mixed and ground to form the film 122. While the discussion above and herein refers to exemplary polymer binders, it is understood that binders of any appropriate type may be included such as monomers and cross-linkers. In the separator film 100, fibrillation was achieved from PTFE (675) 106 with a chain-extended crystal structure. Additional and/or alternative polymer binders PTFE (480), with a chain-folded crystal structure, and polyvinylidene fluoride (PVDF), may increase processability and adjust the mechanical strength, respectively, of the film 100. According to various embodiments, the PTFE (480), with its chain-folded crystal structure, is effective in refining lignosulfonate when mixed together and subjected to shear force. Thus, the PTFE (480) may function as a lubricant, enhancing processability and ensuring and/or assisting in even dispersion within the film. The PVDF facilitated pressure distribution during the rolling process enabling the formation of dense, ultrathin separator films 100 with strain performance, as discussed herein. According to the processability and a XRD patterns of the PTFE (675) and the PTFE (480), PTFE (675) is a kind of PTFE with a chain-extended crystal structure, which is the main reason for the in-situ fibrillation. Meanwhile, the PTFE (480) has a chain-folded crystal structure, which cannot produce in-situ fibrillary.

While the present disclosure includes various embodiments of polymer binders, such as PTFE (675), PTFE (480), and PVDF, the subject claims are not limited to the specific exemplary embodiments. For example, additional polymer binders, such as non-fluorinated polymers or monomers or cross-linkers may be used in the formation of the lignin-based separator film 100. The additional polymer binders may be used in selected wt %, such that the wt % of the examples described herein are altered. The lignin-based separator film 100, therefore, may include polymer binders in addition to those specifically disclosed herein.

Herein four examples, indicated as Example A, B, C, and D include constituents in wt % indicated separated by a “v” herein and listed as wt % PTFE (675) v wt % PTFE (480) v wt % PVDF v wt % lignosulfonate in the compositions, thus Example A is 10v0v0v90, Example B is 05v05v0v90, Example C is 05v0v05v90, and Example D is 05v2.5v2.5v90. These examples are provided as disclosure and discussion of the subject invention. Without or with minor amounts of PVDF the Example films can be made and decreased to 25 μm thickness easily. For sample Example C (05v0v05v90), it is slightly harder to further decrease thickness when it reaches 50 μm. Owing to the property of PTFE (675) of fibrillation by slight grinding, the film of Example A (10v0v0v90) was made at first. The sample with this component can be processed to form a film within 40 minutes, but the film is hard. When the five percent of PTFE (675) was replaced by PTFE (480), the film-formation process can be accelerated and the film can be softened. This process was slowed down, and the film became harder when five percent of PTFE (675) was replaced by the PVDF. When five percent of PTFE (675) was replaced by 2.5 percent of PTFE (480) and 2.5 percent of PVDF at the same time, the processability and flexibility of the film can be balanced.

The dry-fibrillation method includes mainly at least one of two steps: grinding and rolling, and may include both. According to various embodiments, the grinding process is manually regulated (e.g., by hand such as with a mortar and pestle), whereas the rolling process may be mechanized to ensure uniformity. The manual grinding process is similar to kneading dough, and consistency may be maintained by carefully controlling several key parameters, including: 1. raw material quantity: precisely measured to ensure consistent composition across all batches. 2. grinding duration: standardized to achieve uniform particle size before rolling. 3. initial film thickness: controlled before entering the rolling process. 4. rolling parameters: the rolling gap is progressively reduced by 10 μm per cycle until the final thickness is reached; the rolling speed and pressure are kept constant to ensure even compression. The consistency was further monitored and/or confirmed with scanning electron microscope imaging of test samples.

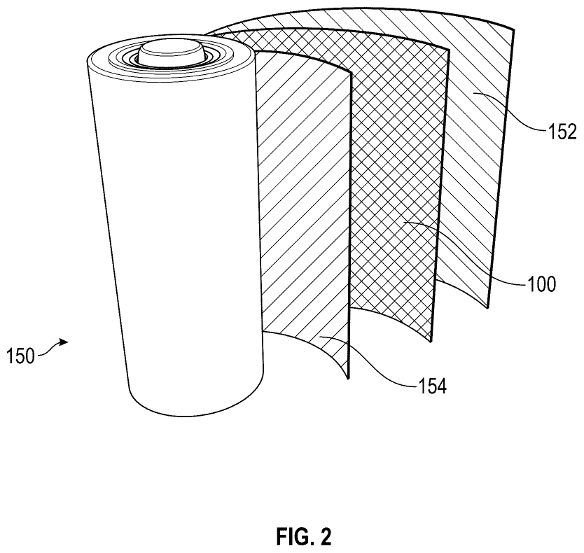

The lignin-based separator film 100 may be used to produce a battery cell 150, illustrated in FIG. 2 according to various embodiments. The lignin-based separator film 100, which may also be referred to as a lignosulfonate based separator film 100, may be positioned to separate an anode 152 of any appropriate composition and a cathode 154 of any appropriate composition. The compositions may include the various test battery cells as discussed herein and may include, for example lithium ion based battery chemistries. The lignosulfonate based separator film 100 may be wetted with a selected liquid electrolyte of a selected composition, including those exemplary discussed herein, the battery cell 150 may include other portions, not specifically illustrated but understood by one skilled in the art, such as a charge collector. Further, more than one of the battery cells may be packaged together to form a battery system.

The film 100 includes micro morphologies, as shown in FIG. 3A and FIG. 3B, according to various embodiments. As discussed above, the film 100 may be formed of a composition having the constituent ratios of as 5 wt % PTFE (675), 2.5 wt % PTFE (480), 2.5 wt % PVDF, and 90 wt % lignosulfonate (LG). The film 100 may be thinned to various intermediate thicknesses and at least to a thickness of about 15 μm, such as can be determined with a SEM, and illustrated in FIG. 3A and FIG. 3B. FIG. 3A illustrates a cross-section SEM view and FIG. 3B is a top view of a SEM image.

Various separator compositions may be made that include the same or similar physical characteristics, as illustrated in FIGS. 3A and 3B and as discussed herein. Generally, however, the compositions may include at least about 90 wt. % lignosulfonates and 10 wt. % polymer binders (also referred to as polymer matrix) matrix with varied amounts of PTFE (675), PTFE (480) and PVDF. Fibrillation may occur in situ (i.e., in the mixture during grinding). For example, the PTFE (675) may be fibrillated and form a polymer matrix by the shear force from grinding because of the chain-extended crystal structure. The in situ fibrillary adheres the PTFE (480), PVDF, and lignosulfonate powders together to form a film with high mechanical strength. Based on the morphological observation (e.g., FIGS. 3A and 3B) and the empirical observation in making the films, PTFE (480), with a chain-folded crystal structure, was broken into smaller particles by the shear force, functioning as a lubricant to help increase the processability and disperse evenly into the film, whereas the PVDF helps to distribute the pressure during the rolling process to achieve dense and ultrathin separators with enhanced strain performance.

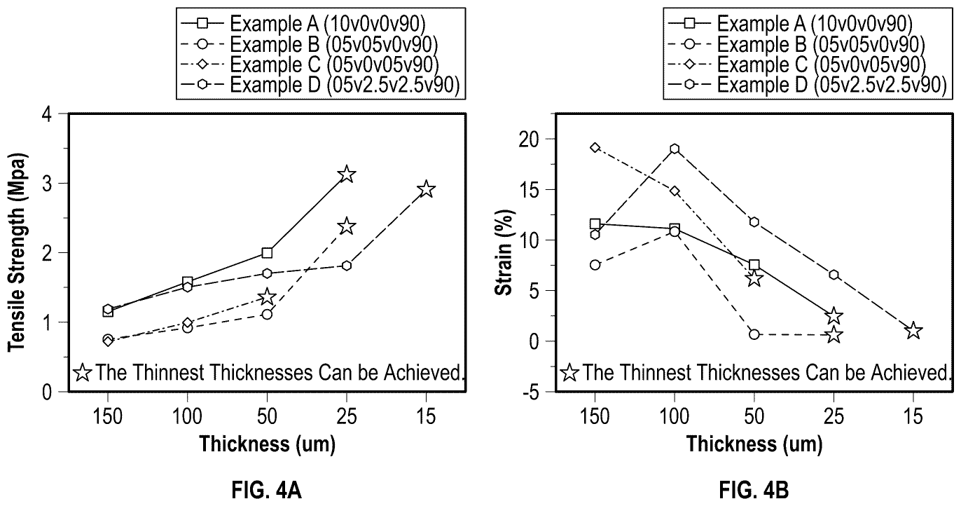

The separator film of various compositions were produced, according to the method discussed above and illustrated in FIG. 1A. Four films were produced and tested for tensile strength at different thicknesses. The results are discussed herein and illustrated in FIGS. 4A and 4B. The four examples, indicated as Example A, B, C, and D include constituents in wt % indicated separated by a “v” herein and listed as wt % PTFE (675) v wt % PTFE (480) v wt % PVDF v wt % lignosulfonate in the compositions, thus Example A is 10v0v0v90, Example B is 05v05v0v90, Example C is 05v0v05v90, and Example D is 05v2.5v2.5v90.

All of the films with a thickness lower than 50 μm demonstrate a tensile strength of MPa level of about 1 to about 3 MPa. The tensile strength increases as the film thickness decreases. The increased strength is attributed to the increased film density and fibrillated PTFE (675) polymer network. The strain as the function of thickness profiles is depicted in FIG. 4B. Comparing the Examples with and without PVDF, e.g. Example A (10v0v0v90) and Example C (05v0v05v90), it is notable that PVDF may significantly improve the strain performance. The strain performance due to the PVDF may be attributed to the larger pressure exerted by the roller during the forming process, discussed above, so the formed separator film can stand greater strain during the rolling process and thereafter with the PVDF content. Partially replacing PTFE (675) by PTFE (480) lead to reduced stretchability, comparing Example A (10v0v0v90) and Example B (05v05v0v90). In Example D, compared to Example A, when 5 wt % of PTFE (675) was replaced by 2.5 wt % of PTFE (480) and 2.5 wt % of PVDF, the strain property was much ameliorated, along with improved processability. This assisted in forming a film of thickness of 15 μm, which suggests that PVDF helps to increase the mechanical strength while PTFE (480) enhances the film processability.

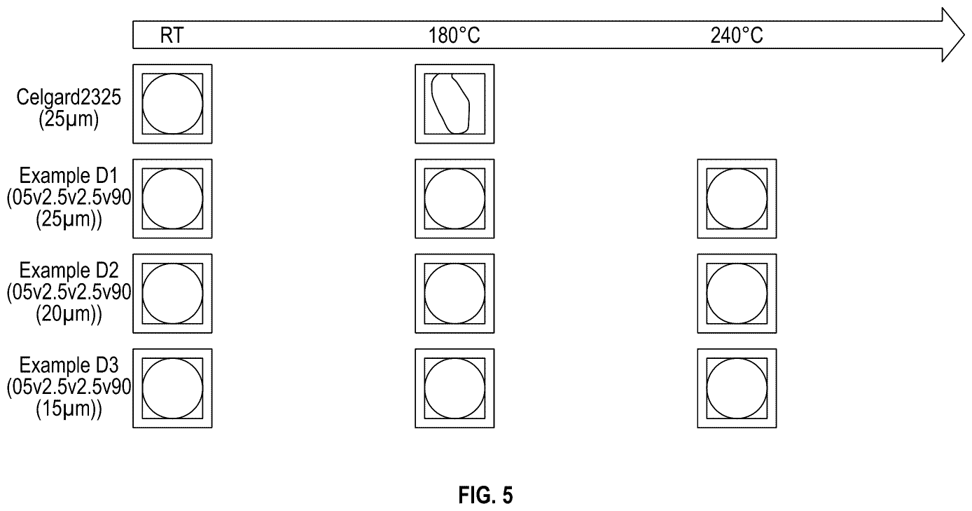

The lignin-based separator film according to the compositions discloses herein also have excellent thermal stability, especially as compared to known separators. For example, Example D (with the composition of 5 wt % PTFE (675), 2.5 wt % PTFE (480), 2.5 wt % PVDF, and 90 wt % lignosulfonate) was used to make films of differing thicknesses. Those were Example D1 with a thicknesses of 25 μm, Example D2 with a thicknesses of 20 μm, and Example D3 with a thicknesses of 15 μm. Each of the Examples D1, D2, and D3 were heated at 100° C., 150° C., 180° C., 200° C., 220° C., 240° C., 260° C., and 300° C. for 15 minutes at each temperature. A comparative example included Celgard®2325. FIG. 5 includes a schematic illustration of the samples at room temperature (RT) and at 200° C. after the 15 minutes. All of the lignin-based separator films examples at the various thicknesses exhibit nearly zero shrinkage up to 180° C. Shrinkage of the lignin based examples that occurred at up to 240° C. was about 1% to about 5%, including about 2% to about 3%, demonstrating excellent thermal stability. Whereas the Celgard®2325 separator experienced severe shrinkage exceeding 40% at 150° C. and becomes transparent above 180° C. and nearly evaporates. For example, Examples D1, D2, and D3 had shrinkage measured at most at about 2% to about 3%, even up to 240° C. The comparative example of Celgard®2325 had about 50% shrinkage at 180° C. and 100% shrinkage at about 200° C. The percent shrinkage being measured as a change in size from an original room temperature size to a size measured after being held at the noted temperature.

Electrolyte soaking experiments, including the liquid electrolytes discussed below, demonstrated the chemical stability of lignin-based separators. Example D1 was soaked in a liquid electrolyte and the electrolyte remained clear after 23 days of soaking. Cyclic voltammetry (CV) tests, as discussed herein, confirmed that lignin-based separators exhibit excellent electrochemical stability. To further assess electrochemical stability, self-discharge experiments using Example D1. Compared to Celgard® 2325 Example D1 exhibited similar capacity retention and voltage drop compared at three days. A two-week calendar life assessment revealed, however, that Example D1 demonstrated better capacity retention than Celgard®2325 having about 100% capacity retention compared to about 98% for the Celgard®2325 separator battery cell.

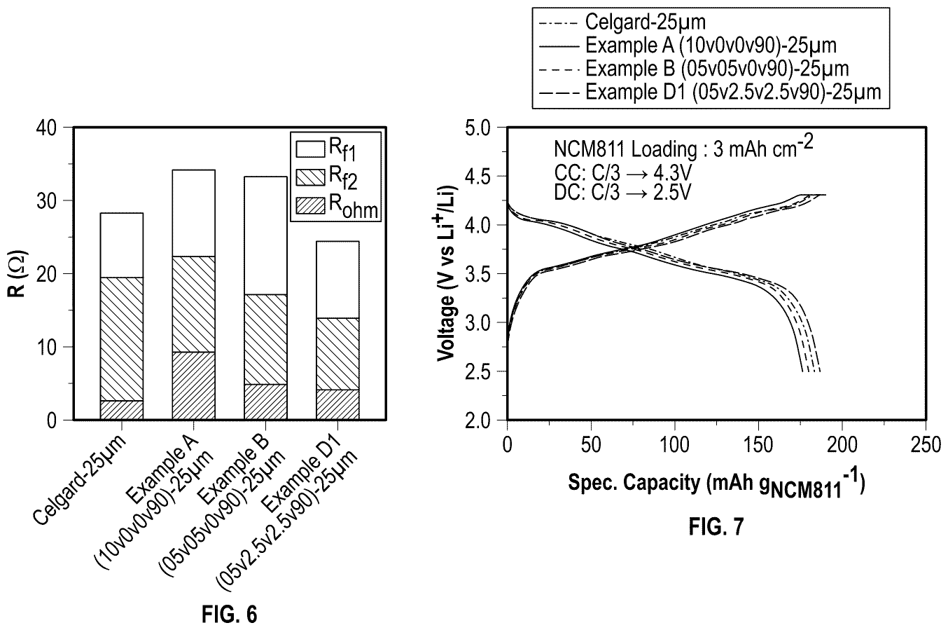

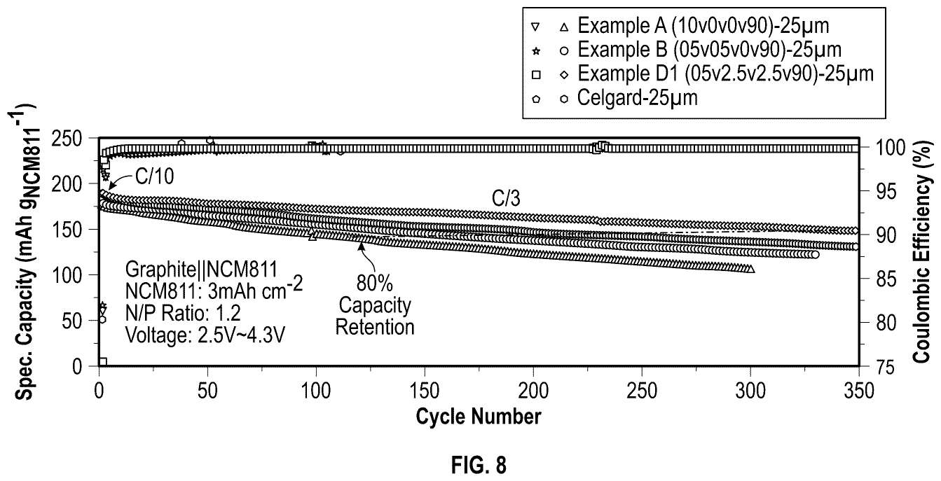

Electrochemical performance of lignin-based separators with different component ratios at a selected thickness of 25 μm was tested in graphite∥NCM811 cells. The known separator Celgard®2325 with a thickness of 25 μm was used as a control group in a graphite∥NCM811 cells. All cells were assembled using NCM811 cathode with a capacity loading of 3 mAh per square centimeter (cm²) and a N/P ratio of 1.2. Freshly assembled cells with lignin-based separator film showed smaller resistance than that of the Celgard®2325. After two formation cycles, battery cells using the lignin-based separator film with compositions of Example A (10v0v0v90) and Example B 05v05v0v90 had measured higher total resistance than the Celgard®2325, whereas that with the component of Example D (05v2.5v2.5v90) showed lower total resistance, as illustrated in FIG. 6 that includes a fitted graph to a selected circuit equivalent circuit where Rₒₕₘ is the ohmic resistance, R_{f} corresponds to the resistance of the SEI (R_{f1}) and CEI (R_{f2}) films (relating to Li⁺ ion diffusion behavior through SEI and CEI films), and Rat signifies the charge transfer resistance between electrodes and electrolytes. The quantified R_{f} impedance contribution of 17.30Ω, 13.37Ω, 12.21Ω and 9.61Ω for Celgard®2325, Example A (10v0v0v90) and Example B (05v05v0v90) and Example D (05v2.5v2.5v90) respectively, indicating that the cells with lignin-based separators delivered faster interfacial Li⁺ ion diffusion than the cell with Celgard®2325 separator. Voltage profiles, illustrated in FIG. 7, of the same Examples and comparative example, illustrate that all lignin-based separator films do not introduce any side reactions to cells. Example D (05v2.5v2.5v90) delivered a higher discharge specific capacity of 186.48 mAh/g compared to 183.10 mAh/g with the Celgard®2325 with a C-rate of C/3. The Example D (05v2.5v2.5v90) separator further exhibited an improved cycling stability compared to that of Celgard®2325, delivering more than 340 cycles compared to 200 cycles with 80% of capacity retention in graphite∥NCM811 cells as illustrated in FIG. 8.

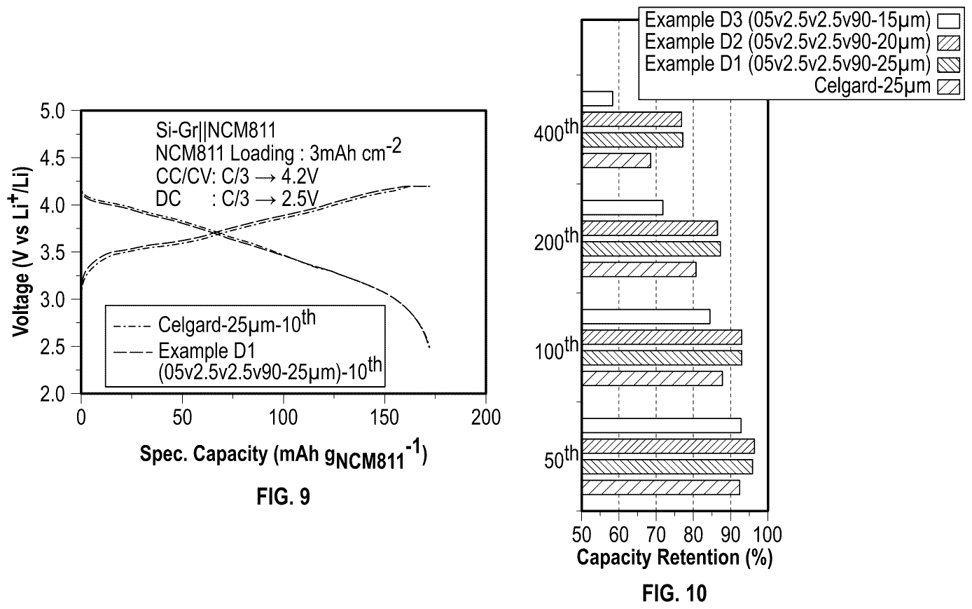

The lignin-based cells of the various examples demonstrated comparable rate performance to that of Celgard®2325. The separator Example D1 (05v2.5v2.5v90 (25 μm)) was further tested in a Si-Gr∥NCM811 cell. As illustrated in FIG. 9, a full cell with the Example D1 separator film delivered comparable specific capacity of 171.57 mAh/g in comparison with a cell with Celgard®2325; and had measured higher Coulombic Efficiency of 99.9% vs. 99.8%, especially in the initial stage of the cycling process. As a result, the Example D1 separator film demonstrated 83% capacity retention at 250 cycles compared with the Celgard®2325 of 70%.

Various thickness of selected lignosulfonate-based separator films were used to determine various characteristics thereof. As noted above, the Example D (05v2.5v2.5v90) was made into films of various thicknesses: Example D1 at 25 μm thickness, Example D2 at 20 μm thickness, and Example D3 at 15 μm thickness and each was used to assemble graphite∥NCM811 battery cells as well as a comparative example battery cell with a Celgard®2325 separator. Battery cells were tested using a constant-current (CC)/constant-voltage (CV) charging protocol with a rate of C/3 ranging from 2.5V to 4.3V at 25° C. Battery cells were activated with two formation cycles, charging and discharging at C/10.

Based on the battery cells assembled as noted above, higher specific discharge capacities of 189.21, 189.44, and 195.11 mAh per gram are delivered by the cells assembled with Example D separator films at thicknesses of 25 μm, 20 μm, and 15 μm at C/10, respectively. While the discharge specific capacity of Celgard®2325 separator is 186.36 mAh g⁻¹. Battery cells assembled with Example D separator films with various thicknesses all exhibit higher capacity retention at the initial cycling stage, as illustrated in FIG. 10. After 50 cycles, the thinnest Example D3 separator film demonstrated 93.0% capacity retention compared to the Celgard®2325 of 92.4%. Furthermore, the separators of Example D1 and Example D2 delivered 96.3±0.3% capacity retention after 50 cycles and 77.4±0.1% capacity retention after 400 cycles, showing excellent cycling stability compared to the Celgard®2325, which had 68.6% capacity retention after 400 cycles. The Example D1 and Example D2 separator films were disassembled from the cells after 400 cycles and tested on both the surface and cross-section morphologies. Based on a review of the after 400 cycles review, the morphologies of the cycled samples were similar to the fresh separator films of the lignosulfonate based separator films. This demonstrates that the cycling process did not break the porous structure of our developed lignin-based separators.

A medium voltage, or the voltage of the battery cell when the battery cell is half full, also was used to determine that the Example D1 and Example D2, exhibited smaller changes in medium voltage over their cycling life. For example, Example D1 showed a voltage drop of only 0.02V from the 3rd cycle to the 400th cycle, and Example D2 showed a drop of 0.05V. In comparison, the Celgard®2325 separator experienced a voltage drop of 0.12V over the same period. The stable medium voltage directly contributes to an improvement of energy density. As a result, the cell using the Example D1 demonstrated a higher energy density retention of 76.2% after 400 cycles, closing to its capacity retention of 77.5%. The Example D2 showed an energy density retention of 75.4%, despite those two cells displaying similar capacity retention, which was 77.5% for Example D1 and 77.3% for Example D2. In comparison, the energy density retention for the cell with Celgard®2325 was only 65.9%, which is lower than its capacity retention of 68.6%.

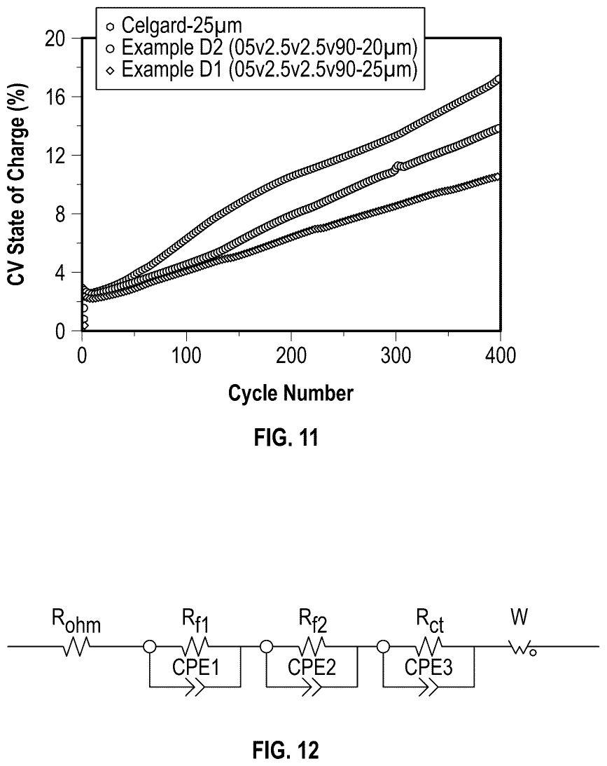

As the divided charging capacity contribution of the CC stage and CV stage, the CC stage of the cells with lignin-based separators contributes more to the cumulative charging capacity than the cell with Celgard®2325 separator, as illustrated in FIG. 11. The CV stage contributed 2.44%, 2.79%, and 2.37% for cells with the Celgard®2325, Example D2, and Example D1 at the 3rd cycle, respectively. After 400 cycles, the charging capacity contribution of CV stage for the cell with Celgard®2325 separator significantly increased to 17.08%. The corresponding values for the Example D2 and Example D1 were 13.77% and 10.54%, respectively. These results indicate that Example D separator films delivered more negligible potential polarization throughout the cycle life, enabling the cells to reach a fully charged state in a shorter time.

An Electrochemical impedance spectroscopy (EIS) test was employed for the battery cells made with the Example D separator films after formation cycles and after 400 cycles at a fully discharged state. The EIS curves were fitted by an equivalent circuit shown in FIG. 12. The equivalent circuit model was utilized to fit the EIS curves. In the high-frequency region, the intercept on the axis, denoted as Rₒₕₘ, represents the electrolyte resistance. The semicircle observed in the high to medium-frequency region corresponds to the resistance of the SEI (R_{f1}) and CEI (R_{f2}) films, relating to Li⁺ ion diffusion behavior through SEI and CEI films, collectively indicated as R_{f}. The semicircle in the intermediate frequency range signifies the charge transfer resistance (R_{ct}) between electrodes and electrolytes. The CPEs are constant phase elements. The W stands for Weber impedance.

After formation cycles, the R_{f} resistances of the cells assembled with the Celgard®2325, Example D2, and Example D1 were 19.0Ω, 9.3Ω, and 9.6Ω, respectively, and the corresponding values increased to 26.6Ω, 17.5Ω and 18.9Ω after 400 cycles. These results demonstrate that lignosulfonate-based separators achieve lower R_{f} within the long-term cycling, which is advantageous for accelerating Li⁺ ion diffusion and reducing polarization. In light of the above, the lignosulfonate based separator films, such as exemplified by the Example D composition, enhance interfacial Li⁺ ion transport compared with the Celgard®2325.

The Example separator films used in the NCM811 battery cells were also investigated using X-ray photoelectron spectroscopy (XPS) to analyze the interfacial components in the NCM811 side and graphite side after 400 cycles. Analysis found four main peaks belonging to C—C (284.8 eV), C—O (286.8 eV), C═O (289.0 eV), and LiCO₃/C—F (290.6 eV) emerged in the C1s spectrum, and two main peaks belonging to C—O (533.9 eV), C═O (532.0 eV) were detected in the O1s spectrum on both cathode and anode sides of the Example D and Celgard®2325 separators. The LiF peaks at around 684.5 eV indicated the formation of LiF-rich SEI and CEI originating from the decomposition reaction of LiPF₆. Peaks were found for the Comparative Example and the lignosulfonate-based separator had the same main peaks in the C1s, O1s, and F1s spectra. However, main peaks were detected in the S2p regions on the surface of the NCM811 cathode and graphite anode when using the lignosulfonate-based separator, such as the Example D composition. The peaks in the XPS analysis at 169.4 eV and 170.6 eV match-SO₂CF₃ species. The XPS peaks at 168.3 eV and 169.2 eV correspond to ROSO₂Li. No XPS peaks were detected at the corresponding binding energy positions for the cell with Celgard®2325. These results indicate that the sulfonate functional group participates in the modification of the CEI and SEI layers. The battery cells with lignin-based separator films show weaker intensity using XPS of the LiF peaks (˜684.5 eV) in both the SEI and CEI compared to those with Celgard® 2325. The abundant sulfonate functional groups in lignosulfonate-based separators synergize to aid in constructing of Sulfur rich CEI and SEI, reducing film resistance, facilitating ion transport, and contributing to a more robust cycle life.

In addition to the various capacity, strength, and other tests discussed above, the example and comparative example separators were analyzed the lignosulfonate based separators were found to wet at least as well as the comparative example Celgard® 2325. Further, per the Brunauer-Emmett-Teller (BET) method to quantitatively analyze the surface area and pore size distribution of the Example D separators with varying thicknesses (15, 20, and 25 μm). The Example D1 (25 μm) separator exhibited the highest specific surface area of 1568.773 m² g⁻¹. The Example D2 (20 μm) separator demonstrated a 36.8% reduction in specific surface area compared to the Example D1 separator. In contrast, the Example D3 (15 μm) separator displayed a significantly lower specific surface area of only 5.045 m² g⁻¹. Pore size distribution analysis also shows that the Example D1 separator has higher incremental pore volume and number than Example D2 and Example D3 separators for all sizes of pores. The reduction in pore size and volume/number may be attributed to prolonged pressure on the lignin material during the fabrication process.

Thus, lignosulfonates are utilized to produce lithium ion battery separators using polymer binder dry fibrillation process. As discussed above, the process includes fibrillation of one or more constituents of the separator composition without a liquid, such as a solvent. The processing, without a liquid, causes fibrillation of at least a portion of the polymer binder. Again, the polymer binder may include the various specific examples discussed above and/or other appropriate polymer binders. Other appropriate polymer binders include non-fluorinated polymers or monomer, monomers, crosslinkers, and or combinations thereof and/or combinations with the above specific examples.

The lignosulfonate-based separators exhibited zero thermal shrinkage up to 180° C. owing at least in part to the high thermal stability of the lignin and a PTFE matrix, such as formed with the above discussed polymer binders. Furthermore, the prepared Example separator films were used to make full battery cells of graphite∥NCM811 and Si-Gr∥NCM811. The graphite∥NCM811 full cells using the lignosulfonate-based separators (e.g., Example D (05 wt % PTFE (675), 2.5 wt % PTFE (480), 2.5 wt % PVDF, and 90 wt % lignosulfonate) separators, at both 20 μm thickness and 25 μm thickness) demonstrated smaller polarization, robust cycling performances, and excellent capacity retention. The abundant sulfonate functional groups in lignosulfonate effectively induced the formation of Sulfur rich SEI and CEI layers, reducing film resistance and facilitating ion transport. After 400 cycles at a C-rate of C/3, improved capacity retention of 8% and energy density retention of 10% was achieved compared to battery cells prepared with Celgard®2325 separators.

The various tests discussed herein were performed according to the standards noted below, or above if separately stated, and with the devices and noted herein. The morphologies of the lignin-based separator films discussed above are determined by using an ultra-high-resolution scanning electron microscope (SEM) of JEOL 7500F at the Michigan State University Center for Advanced Microscopy. The tensile testing was conducted using UniVert from CellScale. Rectangular samples with a width of 12 mm and different thicknesses were used. The X-ray photoelectron spectroscopy (XPS, Thermo Scientific) data were collected at the Michigan Center for Materials Characterization using the Kratos Axis Ultra XPS instrument. The X-ray diffraction (XRD) tests were performed using the Rigaku Smartlab X-ray Diffractometer at Department of Chemical Engineering and Material Science at Michigan State University.

The thermal stability performances were tested by a drying oven (Thermo Scientific) and muffle furnaces. The oven was set up at temperatures of 100° C., 150° C., 180° C., 200° C., 220° C. and 240° C., respectively. After setting the temperatures, the selected separators were put into the oven and heated for 15 min at different temperatures. The thermal stability tests over 250° C. were conducted with Thermolyne Small Benchtop Muffle Furnaces (FB1415M). The thermal stability of lignin was analyzed using a TA Instruments Q50. An 8 mg sample of the selected separator film was heated from 25° C. to 105° C. at 10° C./min, held at 105° C. for 20 minutes to remove residual water, and then heated to 800° C. under controlled nitrogen and airflow conditions for thermal stability and oxidation analysis, respectively.

Prepared lignosulfonate-based separator films in the above disclosed tests and Examples, were assembled into CR2032 cells by a Digital Pressure Controlled Electric Crimper for Coin Cells (MSK-160E) available from MTI Corporation. The NMC811 (LiNi_{0.8}Mn_{0.1}Co_{0.1}O₂) cathode sheets and graphite anode sheets are available from NEI Corporation. The Si/Gr sheets were obtained from GM company. The NCM811 cathode sheets with active material loading of 3 mAh per square centimeter were cut into a 14 mm disc and the anode sheets with active material loading of 3.5 mAh per square centimeter were cut into a 16 mm disc for coin battery cells. The active materials loading for both the cathode and anode electrodes were 90%. Two kinds of liquid electrolyte (LE) are used in this work. The LE for graphite∥NCM811 cells is 1M LiPF₆ in EC/EMC (v:v=3:7) with 2% VC. The LE for Si/Gr∥NCM811 cells is 1M LiPF₆ in EC/EMC (v:v=3:7) with 2% FEC and 1% VC. The two LEs are available from Gotion. An amount of LE included 23 μL per mAh for each cell. The battery cells are charged and discharged at 25° C. using the Neware battery testing system. The Electrochemical impedance spectroscopy (EIS) testing was conducted at room temperature and measured by a PARSTAT 4000 electrochemical workstation.

WO 2025/006758A2 published Jan. 2, 2025, having a PCT application No. PCT/US2024/035834, filed on Jun. 27, 2024 and WO2025/064791A1 published Mar. 27, 2025, having PCT application No. PCT/US2024/047651, filed on Sep. 20, 2024, both invented by Chengcheng Fang, et al., are incorporated by reference herein.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

What is claimed is:

1. A battery cell having a separator, comprising:
a separator film that is fibrillated configured to be positioned between an anode layer and a cathode layer;
wherein the separator film is formed of sulfonated lignin with a polymer binder mixed therewith;
wherein the separator film includes a sulfonate functional group that participates in a modification of a cathode electrolyte interphase layer and a solid electrolyte interphase layer;
wherein the separator includes up to about 99 wt % of the sulfonated lignin and about one wt % of the polymer binder.

2. The battery cell of claim 1, wherein the polymer binder includes at least one of a polyvinylidene fluoride, polytetrafluoroethylene, or combinations thereof.

3. The battery cell of claim 2, wherein the separator film includes polytetrafluoroethylene including a first wt % having a first mean particle size and a second wt % having a second mean particle size, wherein the first mean particle size is larger than the second mean particle size.

4. The battery cell of claim 3, wherein the first mean particle size is 675 micrometers and the second mean particle size is 480 micrometers.

5. The battery cell of claim 4, wherein the separator includes about 80 wt % to about 99 wt % of the sulfonated lignin and at least one wt % of the polymer binder, wherein the polymer binder is included as about zero wt % to about 10 wt % of the polytetrafluoroethylene including the first mean particle size, about zero wt % to about five wt % of the polytetrafluoroethylene including the second mean particle size, and about zero wt % to about 5% of the polyvinylidene fluoride.

6. The battery cell of claim 1, wherein the separator film has a thickness of at least about 1 micrometer formed of ground and mixed sulfonated lignin with at least a portion of the polymer binder having been dry fibrillated.

7. The battery cell of claim 1, wherein the polymer binder includes at least one of a cross-linker, non-fluorinated polymer, a monomer, or combinations thereof.

8. A battery cell having a separator, comprising:
an anode layer;
a cathode layer;
a separator film positioned between the anode layer and the cathode layer;
wherein the separator film is formed of a mixture of lignin and a polymer binder;
wherein at least a portion of the polymer binder is dry fibrillated.

9. The battery cell of claim 8, wherein the lignin is sulfonated, wherein the sulfonated lignin is soluble in water and insoluble in organic liquid electrolytes.

10. The battery cell of claim 9, wherein the separator film includes a sulfonate functional group that participates in a modification of a cathode electrolyte interphase layer and a solid electrolyte interphase layer.

11. The battery cell of claim 8, wherein the separator film is at least one micrometer thick.

12. The battery cell of claim 8, wherein the separator film is at most about 50 micrometers thick.

13. The battery cell of claim 8, wherein the separator film includes about 80 weight percent (wt %) to about 99 wt % of the lignin and about one wt % to about 20 wt % of the polymer binder;
wherein the lignin is sulfonated.

14. The battery cell of claim 8, wherein the polymer binder includes at least one of a polyvinylidene fluoride, polytetrafluoroethylene, cross-linker, non-fluorinated polymer, a monomer, or combinations thereof.

15. The battery cell of claim 14, wherein the separator film includes at least 90 wt % of the lignin, and at least one wt % of the polymer binder including between about zero wt % and about 10 wt % of polytetrafluoroethylene and between about zero wt % and about 10 wt % of polyvinylidene fluoride;
wherein the lignin is sulfonated.

16. The battery cell of claim 14, wherein the separator includes polyvinylidene fluoride including a first wt % having a first mean particle size and a second wt % having a second mean particle size, wherein the first mean particle size is larger than the second mean particle size.

17. A method of forming a battery cell having a separator, comprising:
drying a sulfonated lignin and a polymer binder;
after the drying, mixing the sulfonated lignin with the polymer binder to form a mixture;
fibrillating at least a portion of the mixture; and
pressing the fibrillated mixture to form a separator film.

18. The method of claim 17, wherein fibrillating the mixture includes grinding the mixture.

19. The method of claim 18, further comprising:
selecting the polymer binder to include at least one of a polyvinylidene fluoride, polytetrafluoroethylene, cross-linker, non-fluorinated polymer, a monomer, or combinations thereof.

20. The method of claim 19, wherein mixing the sulfonated lignin with the polymer binder further includes mixing about 80 weight percent (wt %) to about 99 wt % of the sulfonated lignin and about one wt % to about 20 wt % of the polymer binder.
